(19) United States
(12) Patent Application Publication
(10) Pub. No.: US 2005/0014560 A1
(43) Pub. Date: Jan. 20, 2005

(54) Method and system for simulating interaction with a pictorial representation of a model

(76) Inventor: Yacob Blumenthal, Rosh Ha'Ayin (IL)

Correspondence Address: NATH & ASSOCIATES, 1030 15th STREET, NW, 6TH FLOOR, WASHINGTON, DC, 20005, US

(21) Appl. No.: 10/440,163

(22) Filed: May 19, 2003

(51) Int. Cl. G06F 17/60; G06F 19/00; G06F 15/16

(52) U.S. Cl. 463/36; 463/30; 705/14; 709/203

(57) ABSTRACT

A method and system displays video images associated with interaction with a still picture. For example, erotic movie sequences of a model may be accessed by a remote computer, to which a user transmits tactile-dependent signals that simulate sexual activity with the model. The remote computer transmits to a client computer one of the stored movie-sequences in accordance with the tactile-dependent signals for display by the client computer. The erotic picture is mounted on an appliance having at least one sensor, and a surface for disposing the picture thereon in registration with each sensor so that each sensor is accessible via a corresponding erogenous zone of the picture. The appliance is connected to the client computer for displaying an erotic movie-sequence based on tactile-dependent signals produced by stimulation of the respective sensors of the appliance via the corresponding erogenous zone of the picture.

### FIELD OF THE INVENTION

This invention relates to interactive display and manipulation of computer images.

### BACKGROUND OF THE INVENTION

During the last ten years the sex industry has started to shift from the high street to the Internet. Within the context of the present invention, we will use the term “erotic” to relate to visual images of a sexual orientation, regardless of where they stand on the scale of “glamour” to “pornographic”. It is estimated today that some 70% of all Internet traffic is sex-related and that the annual revenue of sex magazines has dropped dramatically as a result. This is hardly surprising since the Internet provides free on line access to erotic images of any and every persuasion, at high resolution. Thus, once a web surfer has paid for the connection, he or she can download erotic images for free. Indeed, frequently the surfer does not pay for the connection, since statistics show that over 70% of all sex-related traffic occurs during work hours, presumably at the employer's expense.

Regardless of whether this is to be considered desirable or not, the fact is indisputable that sex is big business and the increasing trend is that people are seeking to assuage their sexual needs via the Internet.

In one aspect, this invention relates to the provision of more realistic and titillating erotic images than can be provided by sex magazines. To this end, one aspect of the invention is directed primarily to the sex magazine industry since it is believed that the invention will add a measure of stimulation that is unattainable in printed publications for sale at non-Internet stores. It is also believed that use of the invention will discourage office surfing and will thereby benefit the employer.

The need for interactive display and manipulation of computer images has been extensively addressed in the patent literature. U.S. Pat. No. 5,844,547 (Minakuchi et al.) discloses an apparatus and a method of operation for manipulating the display of an object on a display device in accordance with sensing a touching contact on a touch pane, superimposed on a display surface of the display device. Movement of the displayed object is simulated in accordance with characteristics of the touching contact on the touch panel adjacent to the displayed object image. Further, object data defining the display of the object image for each of a plurality of different states of the object, display information specifying the shape and physical properties of the object and the current display position thereof and file information relating to the stored data are stored and accessed for interpreting the simulated manipulation of the object by the characteristics of the touching contact therewith, for correspondingly manipulating and displaying the thus manipulated object image.

U.S. Pat. No. 5,174,759 (Preston et al.) published Dec. 29, 1992 discloses a TV animation interactively controlled by the viewer through input above a book page. A video system enables an operator to repeatedly touch a study object to change the action according to dramatics or game on a video display. An educational embodiment enables a student to touch the page of a printed book and effect multiple types of video response, selected on page by the student, educating the student of the meaning of the point in the printed text or graphics touched. A similar embodiment provides a solid object the student touches to effect multiple animations. As noted in col. 9, lines 28ff, the student has the ability to operate the system by touching keys of a keyboard printed on the book page. In so doing the system enters a response to a question posed on the display.

There is no suggestion in Preston et al. to provide an appliance for inputting signals that depict or are suggestive of a sexual theme or of the removal or addition by a model of one or more layers of clothing.

U.S. Pat. No. 5,739,811 discloses a method and apparatus for controlling human-computer interface systems providing force feedback using an interface device manipulated by a user. A microprocessor is provided local to the interface device and reads sensor data from sensors that describes the position and/or other information about an object grasped and moved by the user, such as a joystick. The microprocessor provides the sensor data to a host computer that is coupled to the interface device by a communication bus that preferably includes a serial interface. In a “host-controlled” embodiment, the host computer calculates force values using the sensor data and other parameters of a host application program and sends the force values to the local microprocessor, which directly provides the force values to actuators to apply forces to the user object. In a “reflex” embodiment, the host computer sends high level supervisory commands to the local microprocessor, and the microprocessor independently implements a local process based on the high level command for reading sensor data and providing force values to the actuators using sensor data and other parameters.

U.S. Pat. No. 5,845,263 (Camaisa et al.) discloses an interactive visual ordering system particularly for restaurants for facilitating ordering menu items by a customer. The customer can request the system to display full-color images of a menu item as a help to decide what to order. The customer can also obtain a list of ingredients, method of preparation and nutritional information for a selected menu item. The system includes a portable computer including a data input device; a video monitor electronically connected to the computer; and a set of photo-realistic images digitally accessible to the computer. A set of food item characteristics is digitally accessible to the computer and presentable in alphanumeric form, wherein at least some of the characteristics are associated with at least one of the images. The computer is adapted to display one or more of the images and one or more of the characteristics associated with the image or images on the monitor in response to manipulation of the data input device.

These references are typical of systems allowing image manipulation using touch sensitive sensors. However, the touch sensors merely serve to allow user selection of pre-stored characteristics and do not actually provide the user with an impression of tactile feedback. Tactile feedback is important in a large number of circumstances. For example, tactile feedback provides valuable information about saleable products, which is not assessable from mail order catalogues be they in printed form or computer implemented. For instance, the “feel” of cloth is important when purchasing clothes, particularly, albeit not exclusively, lingerie.

Tactile feedback may also form an essential component of sex therapy. It is known that sexual dysfunction is commonly psychological rather than physio-logical in origin. To this extent, the cure of sexual dysfunction is usually predicated on the gradual building up of a patient's self-confidence, using various means for inducing sexual stimulation. Short of using surrogate partners, which is an extreme and often unacceptable approach, little has been offered to simulate the sensation of feel, notwithstanding its crucial importance in real life.

None of the above-cited references discloses the use of an appliance that depicts or is suggestive of a sexual theme to generate a sequence of tactile-dependent signals that results in the display of an erotic movie sequence that varies in accordance with the sequence of tactile-dependent signals. Moreover, there is nothing in these references that even remotely suggests the desirability of making the input appliance depict or be suggestive of a sexual theme.

My prior application U.S. Ser. No. 09/328,392 filed Jun. 9, 1999 and entitled “Computer implemented method and system for giving a user an impression of tactile feedback” discloses a computer-implemented method and system for giving a user an impression of tactile feedback. A database is compiled of computer-accessible movie sequences of at least one image relating to a predetermined subject and a user employs an appliance shaped to resemble a human body part associated with the at least one image to input tactile-dependent signals to the computer. The computer responds by displaying one of the movie-sequences in accordance with the tactile-dependent signals.

In such a method and system, the appliance can be a photographic image or a three-dimensional model of a sex organ, such as a phallus or vagina. So far as two-dimensional photographic applications of this invention are concerned, various embodiments are described relating to the provides tactile feedback that reinforces the actual sensation of feel associated, for example, with a particular texture such as imitation fur on a child's toy or silk lingerie. Thus, my previous application does address the depiction of erotic images and the provision of tactile feedback on touching textural features associated with those images. My previous application also discloses an appliance that is shaped to resemble a human body part, particularly a sex organ, such that manipulation of the appliance by the user results in the display of an erotic movie sequence that echoes the user's action or is suggestive thereof.

However, there is no suggestion in my previous application as to how the techniques described therein might be used as a vehicle for enhancing the sexual stimulation afforded by conventional erotic magazines as currently distributed in high street stores.

My previous application describes various approaches for displaying images of a general nature based on interaction with a pictorial representation and teaches how such techniques may be used in a child's toy or to market products such as clothing. It also describes use of a computer keyboard or tablet to input tactile-dependent signals to a computer for displaying video sequences associated with the still image. But it does not describe an appliance that may serve to support a still pictorial image and that allows interaction other than simple touch with the still image via sensors in the appliance.

My previous application also relates to the fashion industry so as to provide a potential customer with tangible feedback of the fabric of which clothing is made. But is makes no suggestion to display costume changes by removing layers of clothing so as to reveal underlying layers of clothing, or naked flesh; or for adding layers of clothing as the case may be.

### SUMMARY OF THE INVENTION

It is an object of the invention to give a user an impression of tactile feedback, which allows visual images displayed on a computer or TV screen to replicate actions performed by a user in association with a still picture.

It is a particular object of the invention to display erotic video images on a computer or TV screen that replicate actions performed by a user in association with an erotic picture.

It is another object of the invention to display video images on a computer or TV screen that replicate the act of undressing or dressing a model, particularly one displayed in a picture.

It is yet a further object of the invention to provide a method of doing business that will add value to magazines, such as sex and fashion magazines, and increase their attractiveness to their targeted audiences.

According to a first aspect of the invention, there is provided a computer-implemented method for simulating interaction with a pictorial representation of a model, the method comprising:
(a) receiving tactile-dependent signals transmitted by a user simulating interaction with a pictorial representation of the model,
(b) accessing one of a plurality of stored movie sequences of said model based on the tactile-dependent signals, and
(c) transmitting to a client computer said one of said movie-sequences for display on a display device connected to the computer.

The invention also provides a computer-implemented method for simulating interaction with a pictorial representation of a model, the method comprising:
(a) using an appliance in association with the pictorial representation of the model to input tactile-dependent signals to a computer, and
(b) displaying on a display device connected to a computer a movie-sequence in accordance with said tactile-dependent signals.

An appliance for use in conjunction with an erotic pictorial representation of a model for providing sexual stimulation according to the invention comprises:
a casing for housing at least one sensor, and
a surface for disposing the pictorial representation thereon in registration with the at least one sensor so that interaction with an erogenous zone of the pictorial representation is sensed by the at least one sensor;
said at least one sensor being adapted to convey tactile-dependent signals to a computer connected thereto in response to interaction with the erogenous zone of the pictorial representation for displaying on a display device of the computer an erotic movie-sequence in accordance with said tactile-dependent signals.

Preferably, at least one of the sensors in such an appliance is accessible via an aperture in the pictorial representation, which typically is a photograph of the model. The sensor may, for example, comprise a bore containing a plurality of longitudinally displaced sensors that are successively actuated via an implement inserted into the bore. Such a sensor may be disposed so as to be in registration with the image of the model's mouth in the pictorial representation so as to be actuated by inserting a finger, or other implement, into the sensor via an aperture in the photograph. Likewise, a different sensor may be disposed so as to be in registration with the image of the model's panties in the pictorial representation so as to be actuated by simulation of vaginal insertion into the sensor of a finger, or other implement.

Unlike the prior art, the tactile-dependent signals are not used to select pre-stored images on a one-to-one basis but rather allow selection of pre-stored images according to the order, rate and/or pressure with which a sequence of touch sensors are contacted. Moreover, in the prior art, there appears to be no suggestion to associate an appliance with an image to be displayed such that the appliance allows for the communication of tactile-dependent signals to the computer which processes the image. Thus, the prior art merely teaches the use of touch panels, for instance, for selecting an image to be displayed. Several touch panels or touch-sensitive areas of a display device have also been provided, each for selecting a different respective image to be displayed. However, the display of movie or animated image sequences based on interaction with touch-sensitive elements associated with a pictorial representation of a model has not been proposed hitherto. Most important, the invention provides tactile feedback that reinforces the actual sensation of feel associated, for example, with a particular texture.

According to a specific embodiment of the invention, sensors may be provided that detect partial or total removal of outer layers of clothing so as to reveal underlying layers of clothing, or naked flesh. This feature of the invention is beneficial not only for providing sexual stimulation but also may be used for online fashion shopping where an outer layer of clothing, such as a coat, may be removed so as to reveal underlying layers thus allowing a complete costume to be checked out.

According to a further embodiment, a camera is provided to image a user's interaction with the picture of the model and to simulate such action more accurately in the video sequence.

### BRIEF DESCRIPTION OF THE DRAWINGS

In order to understand the invention and to see how it may be carried out in practice, some preferred embodiments will now be described, by way of non-limiting example only, with reference to the accompanying drawings, in which:

FIG. 1 is a block diagram showing functionally a system according to the invention;

FIGS. 2a and 2b show details of an erotic picture of a model disposed on an appliance according to the invention for use with the system shown in FIG. 1;

FIG. 3 is a flow diagram showing the principal steps associated with a method for providing sexual stimulation using the system depicted in FIG. 1;

FIG. 4 is a pictorial representation of a penetration sensor for use with the appliance shown in FIG. 2a;

FIG. 5 is a pictorial representation showing a plan view of the penetration sensor depicted in FIG. 4;

FIG. 6 is a schematic representation of the penetration sensor depicted in FIG. 4 showing its mode of operation;

FIG. 7 is a schematic representation of an object intersecting an infrared beam in the penetration sensor depicted in FIG. 4;

FIGS. 8a and 8b are pictorial representations of a plan view of the appliance shown in FIG. 2a depicting location sensors;

FIG. 9 is a pictorial representation of an accessory used with the appliance shown in FIG. 2a;

FIG. 10 is a pictorial representation of a protrusion sensor for use with the appliance shown in FIG. 2a;

FIG. 11 is a pictorial representation of an appliance having one or more motion sensors for detecting and allowing simulation of movement or removal of clothing;

FIG. 12 is a pictorial representation of an appliance having a camera for imaging a user's interaction with the appliance;

FIG. 13 is a flow diagram depicting the principal operating steps carried out either by the computer or the processor in the embodiment of FIG. 12; and

FIG. 14 is a flow diagram depicting the principal operating steps carried out in accordance with a method according to the invention for promoting magazines.

### DETAILED DESCRIPTION OF THE INVENTION

In the following description, the same reference numerals are used to refer to identical components that are common to one or more embodiments.

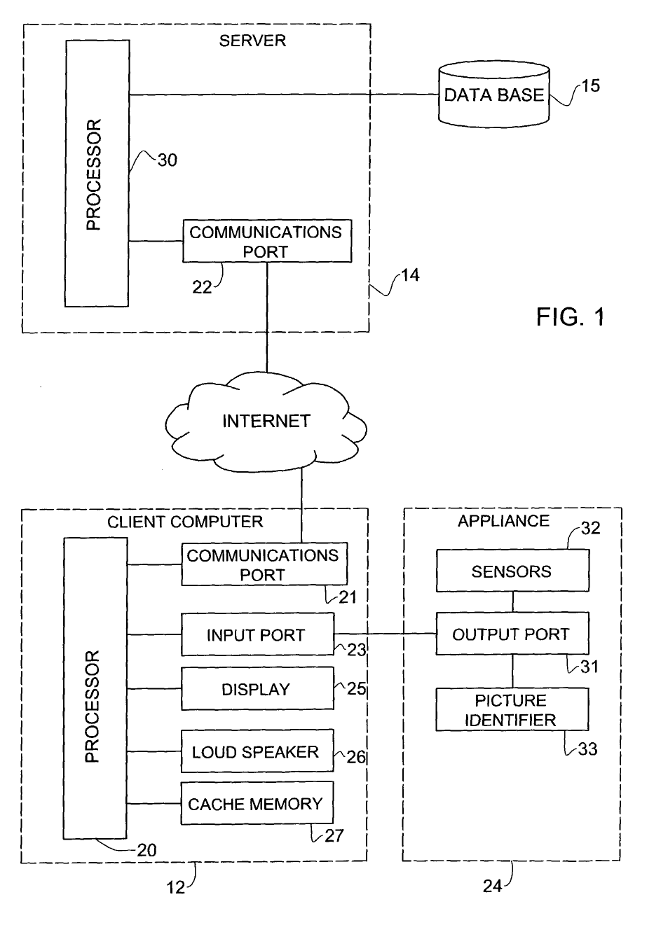

FIG. 1 shows a computer-implemented system depicted generally as 10 for giving a user 11 an impression of tactile feedback. The system 10 comprises a computer 12 (constituting a client computer) coupled via a communication line 13 through the Internet to a server 14 (constituting a remote computer) capable of accessing a bulk memory 15 storing therein a plurality of computer-accessible erotic movie sequences 16 of different models (constituting a model) performing various sexual acts. The user purchases a photograph of the model, typically from a high street store such as a newsagent or adult shop. The photograph is provided with apertures corresponding to erogenous zones of the model such as her mouth, breasts and lower regions. In order to enhance the erotic appeal of the photograph, appropriate ones of the apertures may be covered with material simulating clothing and having the look and feel of lingerie.

The client computer 12 includes a processor 20 coupled to a communications port 21 for coupling to a corresponding communications port 22 in the server 14. An input port 23 is coupled to the processor 20 for coupling an appliance 24 thereto as will be explained shortly. Also coupled to the processor 20 is a display 25 for displaying erotic movie sequences downloaded from the server 14. Likewise, a loudspeaker 26 coupled to the processor 20 allows sound data associated with the movie sequences to be vocalized. A memory 27 coupled to the processor 20 allows downloaded data to be cache and pre-processed prior to displaying and vocalizing the video and audio data. The server 14 includes a processor 30 coupled to the communications port 22 and adapted for coupling to the bulk memory 31.

The appliance 24 includes an output port 31 for coupling to the input port 23 of the client computer 12 and a plurality of sensors 32 that are adapted to produce tactile-dependent signals that are fed to the client computer 12 and subsequently fed to the remote server 14. Likewise, a picture identifier 33 may be provided in the appliance 24 for producing a signal that uniquely identifies a picture placed in association therewith. This allows a dedicated subset of erotic movie sequences to be downloaded from the server 14 relating specifically to the model depicted in the picture.

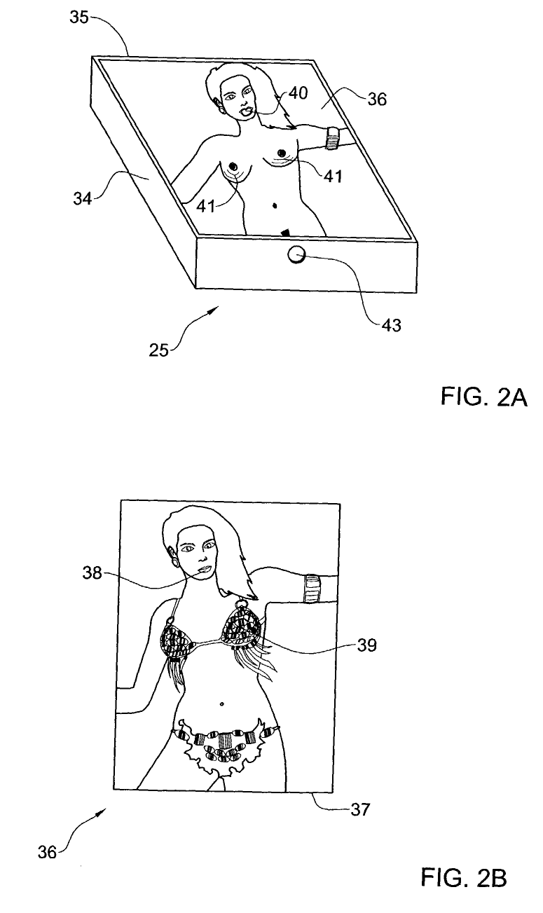

FIG. 2a is a perspective view of the appliance 24 having a casing 34, an upper surface of which serves as an operating surface 35 for disposing thereon a picture 36 shown in more detail in FIG. 2b. The picture 36 includes a substrate 37 depicting a model whose mouth is cut-away to reveal an aperture 38 and whose breast is likewise cut-away to reveal a pair of apertures 39. The appliance 24 is provided with a corresponding penetration sensor 40 that is spatially located on the operating surface 35 so that when the picture 36 is placed thereon in proper registration the penetration sensor 40 is properly aligned with the aperture 38. Likewise, simulated breasts 41 protrude from the operating surface 35 of the appliance 24 and are spatially located so that when the picture 36 is placed thereon in proper registration the simulated breasts 41 protrude through the apertures 39 in the picture. If desired the simulated breasts 41 may be interchangeable so as to simulate different breast sizes. The apertures 39 may be covered with fabric having erotic connotations such as chiffon or silk and conjuring up in the user's mind lingerie such a bra. Likewise, a lower region 42 of the picture 36 may be covered with silky material simulating panties and having the look and feel of lingerie for covering another penetration sensor mounted in a lower edge of the appliance. The movie sequence thus obtained in consequence to rubbing or stimulating these areas provides tactile feedback that gives the user the impression that he is actually feeling the lingerie on the displayed model.

The user, in this case a potential customer, purchases the picture 36 from a suitable sales outlet and disposes it on the operating surface 35 of the appliance 24 in proper registration therewith. To this end, the picture 36 may be of a standard size and there may be provided elevated corner brackets on opposite diagonals of the operating surface 35. Alternatively, the boundary of the picture may be marked visually; or most simply the apertures 39 may be dimensioned such that when both the simulated breasts 41 protrude therethrough, the remaining apertures are also in proper registration with their respective sensors.

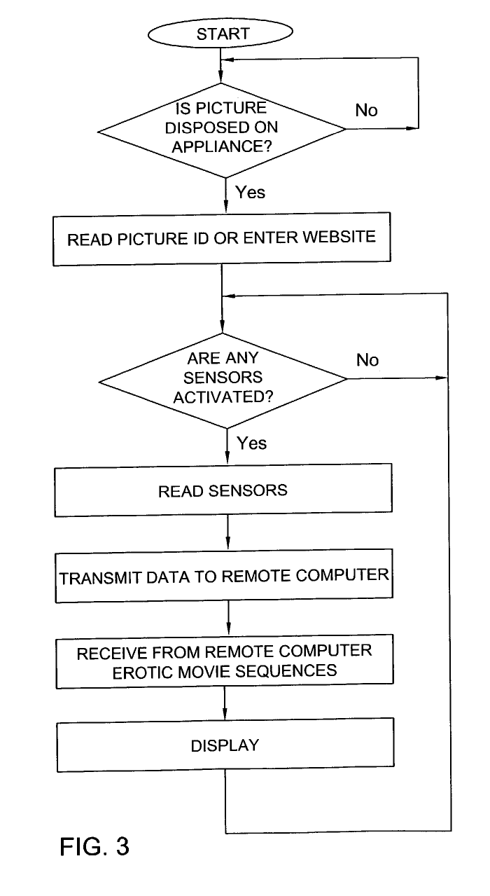

Preferably, the video sequences downloaded from the server 14 correspond to the model depicted in the picture 36. One way to achieve this is to identify the picture or at least the model shown therein. This may be done manually by means of a suitable selector (not shown); or a back surface of the picture 36 may be provided with a barcode that overlies a barcode reader in the operating 35 surface of the appliance. By such means, the identity of the picture 36 may be read automatically when the picture is placed on the operating surface of the appliance and data corresponding to the picture's identity or to the model's identity may be conveyed to the client computer 12 for forwarding to the server 14. Alternatively, as will be explained below with reference to FIG. 3, each picture may be associated with a different website and the user can use a web browser in the client computer 12 to access the appropriate website via a hyperlink associated with the picture.

However, it may be desired to employ the picture 36 merely as a generic stimulus for downloading video sequences showing a model performing various erotic acts, and not necessarily the model depicted in the picture 36. This allows the server 14, for example, to select video sequences based on the sensor signals but not restricted to any particular model and, of course, it simplifies the appliance 24 and the picture 36 since they no longer need to be coordinated in any way.

The erotic movie sequences are coordinated to the sensor signals. For example, when the simulated breasts 41 are stroked or squeezed by the user 11, signals are conveyed to the server 14 resulting in a movie sequence of images being displayed showing a model performing similar motions on her own body. Sound data may also be downloaded for vocalization by the loudspeaker 26. The processor 30 is preferably adapted to convey video data to the client computer 12 at a rate that is dependent on the rate at which the sensors 32 emit signals so that the model can speed up or slow down her actions based on the urgency of the user's manipulation of the various sensors. Alternatively, the data may be downloaded to the client machine 12 and buffered in the cache memory 27 for processing by the processor 20 prior to displaying and vocalizing.

FIG. 3 is a flow diagram showing the principal steps associated with use one embodiment of the invention for downloading erotic video sequences through the Internet. An erotic picture of a model distributed by a service provider is purchased from a suitable sales outlet and placed on the appliance. Printed on the back of the picture or otherwise associated therewith is a website at which there are stored erotic movie sequences corresponding to the picture. The user connects to the website. The website downloads a Java applet to the user's computer which awaits receipt of a signal therefrom. Java is a trademark of Sun Microsystems Inc. of Santa Clara, USA. Upon receipt thereof, the signal is decoded and a corresponding movie file is downloaded to the computer for output. The movie file may contain video data for display on the display device, and/or sound data for reproduction via the loudspeaker.

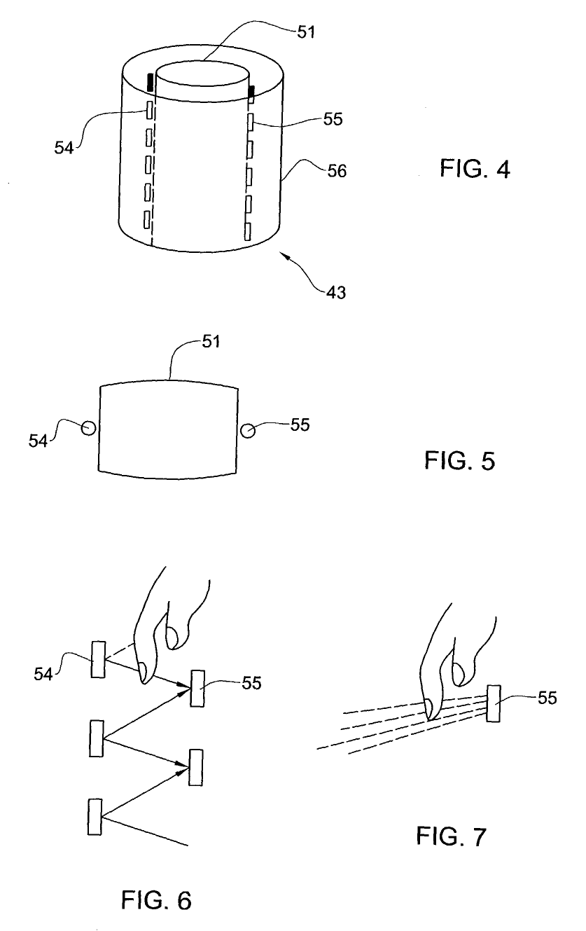

The manner in which sensor signals are produced is explained below with reference to FIGS. 4 and 5 of the drawings. However, as noted above, the sensor signals not only provide an indication of the depth of an object in the penetration sensors, for example, but also the rate at which an object is inserted therein. This may be used to download video sequences at different rates or, again as noted above, the client computer may cache all downloaded move sequences for subsequent processing prior to rendering. By such means, the sound may be separated from the video and the video component may be displayed at a rate that is dependent on the rate at which the sensor signals are generated without speeding up or slowing down the associated sound which is vocalized at a constant speed so as not to change its pitch.

It will be understood that the flow diagram shown in FIG. 3 is simplified and partial. In practice, on connecting to a particular website, data is pre-fetched to the user's site thus obviating the need for each page of sound or graphics data to be downloaded from the website in direct response to its selection if it already exists in the user's cache. It will also be appreciated that the data can be fed to the user's computer locally via bulk storage media such as CD-ROM or DVD. According to one approach, a demo version of the application may be downloaded through the Internet or through the telephone line via a modem and a commercial version on DVD may then be purchased for continued use. In this case, of course, there is no need for explicit identification of the picture since the DVD implicitly identifies it.

FIG. 4 shows pictorially the penetration sensor 43 having an internal bore 51 formed of transparent material into which a body member, such as a finger, may be inserted and having sensors 52 disposed along an outer surface 53 thereof so as to provide an indication of depth of penetration of a member inserted therein. Such a penetration sensor 43 may serve as a surrogate vagina allowing a user to insert a body member so as to activate the sensors 52 at variable rate and pressure. Thus, as the user's member penetrates further into the bore 51, successive sensor signals are produced. The computer may be programmed to display images having stronger erotic content in response to increased penetration. Each sensor 52 comprises an infrared light source 54, such as an LED, and a corresponding pair of staggered infrared detectors 55 mounted on opposite surfaces of the sensor 43, such that light emitted by any one of the infrared light sources 54 strikes two infrared detectors 55. The complete arrangement may be encased within a surrounding housing 56.

FIG. 5 shows a detail of the penetration sensor 43 in plan view. The outer surfaces of the sensor 43 adjacent the infrared light sources 54 and the infrared detectors 55 are flattened either by preforming the internal bore 51 with flat sides or by truncating the side-walls or by forming the surrounding housing 56 with flat side walls so that when the internal bore 51 is inserted therein, the material thereof proximate the infrared light sources and detectors is squashed, thereby producing the desired flattening effect.

The flattening of the side walls of the internal bore 51 adjacent the light sources and detectors ensures that light emitted by the infrared light sources 54 propagates directly through the side wall of the penetration sensor 43 and exits the opposite side so as to strike the staggered pair of detectors 55. If a completely cylindrical cross-section were employed, at least some of the light emitted by the infrared light sources 54 would scatter and miss the detectors 55. This would at best reduce the intensity of the signal received thereby and is unsatisfactory.

FIG. 6 is a schematic representation of the penetration sensor 43 showing its mode of operation. Thus, as a user inserts a finger or other object into the internal bore 51 of the sensor, light from the infrared light sources 54 is intersected and one of the corresponding pair of detectors 55 stops receiving a signal. The second detector in the same pair does not stop receiving a signal until the user's finger for example intercepts the second detector. Thus, the time taken between the signal to the first detector being at least partially interrupted and the light to the second detector in the same pair being interrupted is a function of the rate at which the user inserts his finger into the penetration sensor 43.

FIG. 7 shows schematically a beam of infrared light 56 emitted by one of the infrared light sources 54 striking respective detectors 55. It is seen that a cross-section of the light beam 56 is elongated i.e. oval in shape owing to the staggered displacement of the two detectors 55 relative to the corresponding sensor 54. As a result, as an object is inserted into the penetration sensor 43, it cuts the light beam 56 obtusely (i.e. non-normally) and the width of the cross-section of the light beam 56 that must be traversed by the object before light is fully interrupted from reaching the detector 55 is larger than would be the case if a single detector 55 were disposed directly opposite a light source 54. This allows better discrimination and, in practice, permits a larger number of discrete binary levels to be counted between the object starting to interrupt the beam to the first detector and completely interrupting the beam to the second detector. The resulting higher resolution signal permits more discrete frames of a video sequence to be displayed in the time interval that elapses between the object's penetration between adjacent detectors.

Preferably, the inside surface of the internal bore 51 is formed of an elastic material allowing for radial expansion and contraction depending on the overall width of the body member inserted therein. A male user suffering from impotence, for example, who inserts his penis into the bore will exert pressure against the inside surface of the bore 51 whose magnitude is a function of his penile width. This, in turn, is clearly correlated with the strength of his erection and thus sensor signals are produced which characterize rate of “pumping” and strength of erection. The computer 12 is then programmed to display movie-sequence depicting erotic images which may, for example, mirror the patient's actions in response to tactile stimulation of the appliance. It has been found that such images stimulate the patient further and give rise to greater strength of his erection, thus further increasing the pressure on the sensors 52. The computer may be programmed to display images having stronger erotic content, this inducing yet further stimulation and aiding the patient to reduce anxiety and by such means overcome his impotence.

It will be understood that like penetration sensors 43 may be used to simulate other orifices of the human body such as mouth and anus. Additionally, these sensors may be supplied in different sizes and may be interchangeable.

The breast sensors 41 may, at their most basic, be simple switches that are opened or closed by the user's manipulation of the breasts. Preferably, the breast sensors 41 include multiple pressure sensors that allow the location of the user's hands on the breast sensors to be sensed. When one or both of the breast sensors 41 are operated, the resulting signals are conveyed by the appliance 24 to the client computer 12 and thence to the server 14 thus allowing extraction of suitable video frames from the database 15 for uploading to the client computer 12. In practice, as soon as data indicative of the still picture is conveyed to the server 14, video frames may be pre-fetched by the client computer 12 and stored in cache memory 27. This obviates the need constantly to download video frames in real time and greatly improves apparent response time.

Preferably, the material depicting the bra and panties is at least partially displaceable, thus allowing a user to insert his finger into a hem of the panties or the cup of the bra and displace them downwards as if undressing the model. As shown in FIGS. 8a and 8b, an ultrasound emitter 60 disposed towards an upper edge of the appliance 24 emits an ultrasound signal that strikes the user's finger and is reflected thereby back toward an ultrasound detector 61. The time taken for the ultrasound signal to cover the round trip is a function of the distance of the finger from the ultrasound emitter/detector pair and may therefore be used to determine whether the user's finger is proximate the girl's bra or her panties and produce a corresponding proximity signal. The proximity signal is conveyed to the client computer 12 and thence to the server 14 and allows selection of a video sequence depicting a man's finger removing the girl's bra or her panties as appropriate.

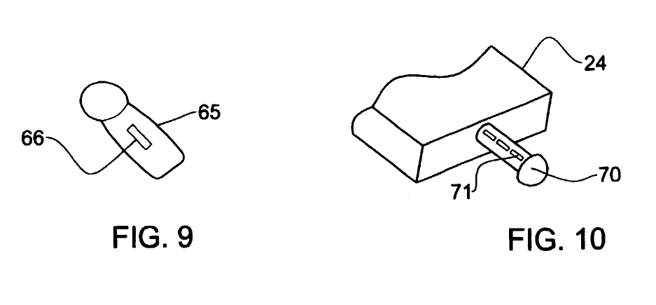

FIG. 9 is a pictorial representation of an accessory 65 such as a sex toy used with the appliance 24. The accessory 65 may, for example, be a dildo having a magnet 66 inside that, when placed near the girl's panties, interacts with a corresponding magnetic reed switch (not shown) in the appliance, causing the reed switch to close and convey a suitable signal to the client computer 12. This in turn may be conveyed to the server 14 for causing a video sequence depicting use of the sex toy to be downloaded by the client computer. The accessory 65 may be encoded as known in the art so as to emit a characteristic infrared (or other) signal that is detected by a suitable infrared (or other) detector in the appliance and thus decode the kind of accessory being employed. This information also may then be conveyed to the server 14 for causing a video sequence depicting use of the appropriate accessory to be downloaded by the client computer.

It will also be appreciated that while the invention serves as a vehicle for enhancing the sexual pleasure provided by “still” pictures, it also has a therapeutic value, to which some reference has already been hinted above. Thus, as noted, the appliance may be designed for aiding impotence and allowing insertion of a patient's penis into the penetration sensor 43. As the patient's penis penetrates further into the bore 51, successive sensor signals are produced allowing the computer to display images having stronger erotic content in response to increased penetration, thus inducing yet further stimulation and aiding the patient to reduce anxiety and by such means overcome his impotence. Also, since the penis contracts after orgasm, monitoring the depth of penetration allows the moment of orgasm to be determined.

Furthermore, the sensors 52 shown schematically in FIGS. 4, 5 and 6 may themselves be provided with actuators responsive to signals that are downloaded together with the movie sequences according to the erotic content thereof, for example. By such means, tactile sensation can be fed back to the user. By way of example, the sidewalls of the internal bore 51 of the penetration sensor 43 may be contracted by means of a solenoid which is actuated via a signal downloaded from the website when the model shown in the video sequence closes her legs, thereby squeezing the user's penis.

Likewise, while the invention has been described with particular reference to the provision of penetration sensors, the appliance may equally be provided with one or more sensors that protrude from the operating surface through a corresponding aperture in the picture when placed thereon.

FIG. 10 shows pictorially an alternative embodiment depicting the appliance 24 according to such an embodiment and including a generally cylindrical phallic-shaped protrusion sensor 70 having sensors 71 disposed along an outer surface thereof, for use by female patients in a similar manner. Thus, as the sensor 70 is inserted deeper into the user's vagina or mouth, the sensors 71 produce successive signals indicative of depth of penetration. The computer may be programmed responsive to the sensor signals for displaying images having stronger erotic content, this inducing yet further stimulation.

The sensors 71 may be micro-switches whose states (open or closed) are toggled when depressed by the walls of the vagina or by the user's lips or hand. Alternatively, or additionally, they may produce signals whose magnitude is a function of electrical resistance, this in turn varying as a function of moisture in a woman's vagina and decreasing in inverse proportion to her sexual stimulation.

The appliance 24 may also include sensors allowing the displayed image or the sound track to be varied according to other physiological characteristics. Thus, for example, heart rate as well as body temperature and resistance may be monitored, all of these being indicative of the user's state of arousal: the image or sound track being selected in accordance with a combined function of the measured variables.

FIG. 11 depicts yet a further embodiment of the invention showing an appliance 24 for mounting thereon a picture of a model wearing clothing such as bra 75 or panties 76. The bra 75 is attached to the appliance 24 via straps 77 to which is attached a reticle 78 comprising a plurality of evenly spaced IR-reflecting bands 79. A far end of the strap 77 is attached to the appliance 24 so as to allow movement of the strap. This may be done either by forming the strap of an elastic material or by anchoring the free end of the strap within a slot (not shown) in an operating surface 35 of the appliance so that moving the strap allows it to be progressively withdrawn from the slot. Mounted in association with the reticle 78 are an IR diode 80 and an IR detector 81. The IR diode 80 and IR detector 81 are calibrated so that initially infrared light emitted by the IR diode 80 strikes a lowermost of the bands 79 and is reflected thereby to the detector 81. The spacing between adjacent bands 79 is non-reflective. When the user now starts to pull down the bra 75, the reticle 78 moves with the strap 77. As a result, the infrared light emitted by the IR diode 80 strikes progressively higher bands 79 at a rate that is dependent on the rate of movement of the reticle 78 and is easily calculated from the time taken for adjacent bands 79 to reflect successive signals and the spacing between adjacent bands 79, which is known. The reticle 78 in conjunction with the IR diode 80 and IR detector 81 thus constitute a motion sensor. A strap 85 is likewise attached to the panties 76 and supports a reticle 86 that operates in conjunction with an IR diode 87 and an IR detector 88 in similar manner.

Other types of motion sensor will be apparent to those skilled in the art. Thus, for example, the free end of the strap may be anchored within a slot (not shown) in an operating surface 35 of the appliance to a potentiometer (also not shown) so that pulling on the strap moves an operating handle of the potentiometer. However, since in use the pictorial representation of the model is mounted on the operating surface 35 of the appliance and the bra and panties are then secured, such an arrangement is cumbersome. On the other hand, the free ends of the straps 77 and 85 are easily anchored to the operating surface 35 of the appliance after mounting the pictorial representation of the model and the bra and panties.

It is also to be noted that the same concept finds broader application in the fashion industry to allow layers of clothing to be removed so as to reveal underlying layers of clothing, or naked flesh. Likewise, layers of clothing may be added so as to display the effect of changes to a costume worn by the model. For example, an outer layer of clothing, such as a coat, may be removed so as to reveal underlying layers; or they may be added to complement existing layers thus allowing a complete costume and different color schemes to be checked out, for example.

FIG. 12 shows yet another embodiment where the appliance 24 includes a mount 90 toward an upper edge of the appliance 24 for supporting a camera 91 that images a user's hand 92, for example, as it removes or uncovers an article of clothing, such as the girl's bra 75. The camera's images are conveyed to a computer connected to the appliance and are processed thereby to determine where the user's hand grips the bra 75. The computer may be programmed to superimpose an image of the user's hand on the video sequence that is subsequently displayed in faithful orientation relative to the bra 75 in the appliance. This gives the user the impression that it is his hand that is removing the girl's bra also in the video sequence displayed by the computer. Moreover, from the images of the user's hand, the computer can also determine the color of the user's skin and can download a video sequence to match. Alternatively, the image data may be processed by the processor 20 in the appliance and the processed image data may be conveyed to the computer for further processing.

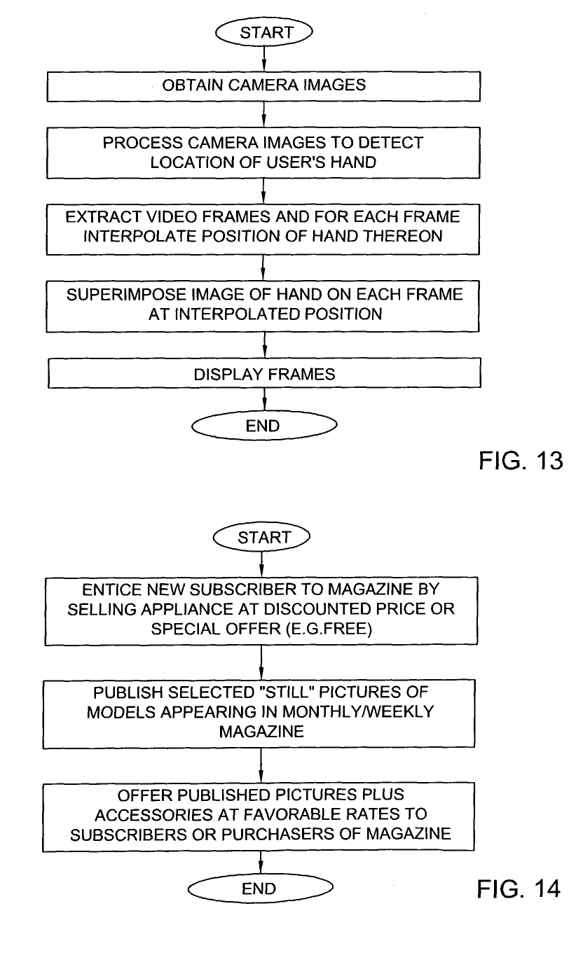

FIG. 13 is a flow diagram depicting the principal operating steps carried out either by the computer or the processor or by them both in combination in such an embodiment. Camera images are processed in order to detect the location of the user's hand. The camera may be enabled as soon as the appliance is energized or may be responsive to sensors attached to the clothing, such as the IR sensors shown in FIG. 11 so that the camera images will be processed only when actual movement of the clothing is detected. In either case, the contour of the clothing is processed in order to determine where the user's hand intersects the contour, thereby allowing location of the user's hand relative to the clothing to be determined.

The computer has access to a database of stored video frames depicting the model shown in the picture removing his or her clothing, layer by layer in response to suitable trigger signals. The computer receives successive images of the user's hand from the camera as it “undresses” the model, and superimposes this image on the stored video frames so that an image of the user's hand appears on the stored images in the same relative location as it does on the picture. By such means, the video frames that are subsequently displayed on the computer or TV screen show the combined images of the original video frames and the user's hand as it peels away the model's clothing layer by layer.

FIG. 14 is a flow diagram depicting the principal operating steps carried out in accordance with a method for promoting magazines. The appliance may be offered as a special discount or even free of charge to a new subscriber to the magazine. Each month, the magazine is published together with pictures of one or more models appearing therein and wearing articles of clothing that simulate clothing worn by the model depicted therein. The articles of clothing are provided with sensors, as described above, that are used to detect movement. The pictures and accessories may be sold to the subscriber for an additional sum but in any case they will likely not be obtainable without either proof of purchase of the magazine or proof of identity as a registered subscriber. In use, the subscriber places the picture on the appliance, attaches any straps as explained above, and then interacts with the picture so as to cause simulated movie sequences of the same model appear on the subscriber's computer screen. By such means, the magazine content is greatly enhanced and the expected revenue associated with the sale of the magazine will increase.

It will be appreciated that although a particular embodiment has been described, this is by way of example only and it will readily occur to those of average skill in the art that different technical solutions may be applied without departing from the scope of the invention as defined in the claims. For example, although the penetration sensor shown in FIGS. 4, 5 and 6 employ optical sensors, the sensors may be magnetic reed switches comprising a magnetic reed and a magnet disposed on opposing sides of the bore 51. In the absence of any obstruction between the magnetic reed and the corresponding magnet, the corresponding switch is closed. When a body member enters the bore, it obstructs the magnetic reed and the corresponding magnet thereby opening the corresponding reed switch and affording an indication of the depth or extent of penetration.

Likewise, while the invention has been described with regard to the portrayal of sexually graphic images, it will be appreciated that the principles of the invention are equally applicable for the display of non-erotic images. Thus, the still picture mounted on the appliance may representative of a model used by a clothing supplier to model clothes. Proximity or other suitable sensors in the appliance can detect which garment is selected by the user and a video sequence depicting various views of the selected garment may be downloaded.

Furthermore, while the invention has been described with regard to pictures that are used as an adjunct to a magazine, the pictures may also be used as an adjunct to a calendar or indeed may themselves be a calendar or part of a calendar. This is also an attractive commercial feature since calendars are commonly given away at New Year as publicity and marketing attractions.

It should also be noted that while the invention has been described with regard to display of video images on computer displays, such displays also include within their scope virtual displays of the kind commonly embedded in frames or spectacles worn by a user to view a virtual image. In such case, slightly different images may be presented to each of the displays to create stereo images. Virtual reality displays are themselves well known in the art and are described, for example, in U.S. Pat. No. 5,991,085 assigned to i-O Display Systems LLC and entitled “Head-mounted personal visual display apparatus with image generator and holder” whose teachings are incorporated herein by reference.

The invention likewise may be employed in the education field. For example, it is ideal for teaching language to infants. A picture depicting a subject whose detailed vocabulary is to be taught is mounted on the appliance and proximity or other suitable detectors detect the position of the child's finger, for example, on the picture.

It should also be noted that certain embodiments have been described by way of example and without detailed description of interrelationship between different embodiments. However, features of one embodiment may be combined with those of other embodiments in a manner which will be readily apparent to those skilled in the art and the appended claims are intended to cover such combinations.

It will also be noted that whilst some preferred embodiments have been described with particular regard to downloading computer-accessible movie sequences and other files through the Internet, the files may be stored locally on a CD-ROM, DVD or other locally accessible media.

Finally, it will be understood that the invention may also be implemented via a computer program product and a machine-readable medium allowing a computer to display to a user computer-accessible movie sequences of a predetermined subject in accordance with tactile-dependent signals received from the user. Typically, the computer is a web server coupled via the Internet to a client computer to which images are downloaded for display.

In the method claims that follow, alphabetic characters used to designate operations are provided for convenience only and do not imply any particular order of performing the operations.

1. A computer-implemented method for simulating interaction with a pictorial representation of a model, the method comprising:
(a) receiving tactile-dependent signals transmitted by a user simulating interaction with the pictorial representation of the model,
(b) accessing one of a plurality of stored movie sequences of said model based on the tactile-dependent signals, and
(c) transmitting to a client computer said one of said movie-sequences for display on a display device connected to the computer.

2. The method according to claim 1, further including:
(d) transmitting said one of said movie-sequences at a rate that is dependent on a rate of activity determined by said tactile-dependent signals.

3. The method according to claim 1, further including associating a sound-sequence with at least one of the movie-sequences so as to reproduce a sound track with the at least one movie-sequence.

4. The method according to claim 2, further including:
(e) storing a sound-sequence associated with at least one of the movie-sequences so as to reproduce a sound track with the at least one movie-sequence, and
(f) rendering the sound-sequence at a substantially constant rate regardless of variations in the rate of activity determined by said tactile-dependent signals.

5. The method according to claim 1, wherein accessing the movie sequences includes accessing a hyperlink corresponding to a website associated with the pictorial representation of the model.

6. The method according to claim 1, further including:
(g) receiving actuation signals representative of a specified function of the at least one movie-sequence, and
(h) controlling an auxiliary property of the appliance with the actuation signals.

7. The method according to claim 1, wherein the movies sequences depict an erotic theme.

8. The method according to claim 1, wherein the movies sequences depict the model removing or adding one or more layers of clothing.

9. A computer-implemented method for simulating interaction with a pictorial representation of a model, the method comprising:
(a) using an appliance in association with the pictorial representation of the model to input tactile-dependent signals to a computer, and
(b) displaying on a display device connected to a computer a movie-sequence in accordance with said tactile-dependent signals.

10. The method according to claim 9, further including:
(c) transmitting the tactile-dependent signals to a remote computer for receiving the movie sequence therefrom.

11. The method according to claim 10, further including:
(d) transmitting to the remote computer data representing a hyperlink corresponding to a website associated with the pictorial representation of the model for receiving the movie sequence from said website.

12. The method according to claim 9, wherein receiving tactile-dependent signals includes:
i) disposing the pictorial representation of the model in association with the appliance so that at least one erogenous zone of the pictorial representation overlies a respective sensor in said appliance, and
ii) stimulating at least one of the respective sensors of the appliance via the corresponding erogenous zone of the pictorial representation so as to produce the tactile-dependent signals.

13. The method according to claim 9, wherein receiving tactile-dependent signals includes receiving a location-dependent signal indicative of a user's interaction with an article of clothing worn by the pictorial representation of the model.

14. The method according to claim 9, wherein receiving tactile-dependent signals includes imaging a user's interaction with an article of clothing worn by the pictorial representation of the model.

15. The method according to claim 14, further including sending the images to the computer for processing thereby.

16. An appliance for use in conjunction with a pictorial representation of a model for simulating sexual activity with the pictorial representation of the model:
a casing for housing at least one sensor, and
a surface for disposing the pictorial representation thereon in registration with the at least one sensor so that interaction with an erogenous zone of the pictorial representation is sensed by the at least one sensor;
said at least one sensor being adapted to convey tactile-dependent signals to a computer connected thereto in response to interaction with the erogenous zone of the pictorial representation for displaying on a display device of the computer an erotic movie-sequence in accordance with said tactile-dependent signals.

17. The appliance according to claim 16, wherein the at least one sensor is disposed in the appliance so as to be accessible via a corresponding erogenous zone of the pictorial representation and to produce the tactile-dependent signals in response to stimulation of the sensor via the corresponding erogenous zone of the pictorial representation.

18. The appliance according to claim 17, wherein at least one of the sensors is accessible via an aperture in the pictorial representation.

19. The appliance according to claim 18, wherein said at least one of the sensors comprises a bore containing a plurality of longitudinally displaced sensors that are successively actuated via an object inserted into the bore.

20. The appliance according to claim 19, wherein the plurality of longitudinally displaced sensors comprises pairs of IR light sources and corresponding IR detectors mounted on opposite sides of the bore.

21. The appliance according to claim 19, wherein the IR light sources and IR detectors are staggered so that each IR light source directs light to a pair of IR detectors that are angularly displaced relative thereto.

22. The appliance according to claim 16, further including further including an identification decoder responsive to an identification code in the pictorial representation for identifying the model.

23. The appliance according to claim 16, including at least one motion sensor for receiving respective location-dependent signals indicative of a user's interaction with the pictorial representation of the model or with an article of clothing worn thereby.

24. The appliance according to claim 16, including a mount for supporting a camera for imaging a user's interaction with the pictorial representation of the model or with an article of clothing worn thereby.

25. The appliance according to claim 16, wherein the at least one sensor is shaped to resemble a human body part.

26. The appliance according to claim 16, wherein said bore is formed of an elastic material allowing for radial expansion and contraction depending on an overall width of the object inserted therein.

27. The appliance according to claim 16, wherein the sensors are disposed along a length of said bore so as to provide an indication of depth of penetration of the object inserted therein.

28. The appliance according to claim 16, being integral with the computer.

29. The appliance according to claim 16, including auxiliary sensors for measuring auxiliary signals representative of respective physiological variables of the user, whereby the movie-sequences are selected in accordance with a function of the measured auxiliary signals.

30. The appliance according to claim 16, wherein:
a sound-sequence is associated with at least one of the movie-sequences so as to reproduce a sound track with the at least one movie-sequence, and
a loudspeaker is coupled to the computer for vocalizing the sound-sequence.

31. The appliance according to claim 16, further including at least one actuator for controlling an operating characteristic associated therewith, the computer being responsive to the at least one movie-sequence for feeding corresponding actuating signals to the at least one actuator.

32. An appliance for use in conjunction with a pictorial representation of a model for simulating interaction with the pictorial representation of the model:
a casing having a surface for disposing the pictorial representation thereon, and
at least one sensor for detecting interaction with an article of clothing worn by the pictorial representation;
said at least one sensor being adapted to convey tactile-dependent signals to a computer connected thereto in response to interaction with said article of clothing for displaying on a display device of the computer a movie-sequence in accordance with said tactile-dependent signals.

33. The appliance according to claim 32, including a mount for supporting a camera for imaging a user's interaction with the pictorial representation of the model or with an article of clothing worn thereby.

34. An erotic picture for use in conjunction with the appliance of claim 16, said erotic picture comprising:
a substrate bearing thereon an erotic pictorial representation of a model, and
at least one aperture associated with an erogenous zone of the pictorial representation and disposed in the substrate so as to provide access to one of the sensors in the appliance.

35. The erotic picture according to claim 34, further including an identification code for allowing the model to be identified.

36. The erotic picture according to claim 35, wherein the identification code is a hyperlink pointing to a website.

37. The erotic picture according to claim 34, further including material simulating clothing covering at least one of the apertures.

38. The erotic picture according to claim 37, wherein the material has a look and feel of lingerie.

39. The erotic picture according to claim 37, wherein at least one motion sensor component is attached to the material for allowing detection of removal of the material from the model.

40. A picture for use in conjunction with the appliance of claim 32, said picture comprising:
a substrate bearing thereon a pictorial representation of a model, and
at least one layer of material simulating clothing worn by the model.

41. The erotic picture according to claim 40, further including an identification code for allowing the model to be identified.

42. The picture according to claim 41, wherein the identification code is a hyperlink pointing to a website.

43. The picture according to claim 40, wherein at least one motion sensor component is attached to each layer of material for allowing sensing dressing or undressing the material from the model.

44. A method for using the system according to claim 26 by a user inserting an object into said bore, said method comprising the steps of:
(a) producing pressure-sensitive signals produced by movement of said object against the inside surface of the bore, said pressure-sensitive signals having a magnitude that is a function of a width of the object, and
(b) displaying erotic images whose content is a function of the magnitude of said pressure-sensitive signals.

45. A method for using the system according to claim 27 by a user inserting an object into said bore, said method comprising the steps of:
(a) producing successive pressure-sensitive signals produced by movement of said object against the inside surface of the bore indicative of increasing penetration of the object therethrough, and
(b) displaying erotic images whose content is a function of the magnitude of said pressure-sensitive signals.

46. A computer comprising:
a processor for accessing one of a plurality of stored movie sequence of a model based on tactile-dependent signals, and
a communications port for receiving tactile-dependent signals transmitted by a user simulating interaction with a pictorial representation of the model, and for transmitting to a client computer said one of said movie-sequences for display on a display device connected to the client computer.

47. The computer according to claim 46, wherein the processor is adapted to transmit said one of said movie-sequences at a rate that is dependent on a rate of activity determined by said tactile-dependent signals.

48. The computer according to claim 46, wherein the processor is adapted to access a bulk storage medium such as a CD ROM or D.V.D.

49. The computer according to claim 48, wherein the bulk storage medium is coupled to the computer remotely.

50. The computer according to claim 49, wherein the bulk storage medium is associated with a remote server accessible to the computer via the Internet.

51. The computer according to claim 50, being adapted to process camera images of a user's interaction with the pictorial representation of the model or with an article of clothing worn thereby and to superimpose an image of the user's hand on the displayed video sequence in faithful orientation relative to the model or with the article of clothing worn thereby.
